(19) United States
(12) Patent Application Publication
(10) Pub. No.: US 2008/0055257 A1
(43) Pub. Date: Mar. 6, 2008

(54) Touch-Sensitive Interface Operating System

(76) Inventor: Juen-Tien Peng, Chung Li (TW)

Correspondence Address: HDSL, 4331 STEVENS BATTLE LANE, FAIRFAX, VA, 22033, US

(21) Appl. No.: 11/470,182

(22) Filed: Sep. 5, 2006

(51) Int. Cl. G06F 3/041

(52) U.S. Cl. 345/173

(57) ABSTRACT

A touch-sensitive interface operating system for applying to search objects of an electronic map or guide route includes a touch-sensitive panel for inputting at least one graphic instruction, a database, and an arithmetic unit. The database stores information relative to the at least one graphic instruction, the electronic map, and relative data. The arithmetic unit obtains the information from the database, and shows the information on the touch-sensitive panel.

### BACKGROUND OF THE INVENTION

1. Field of the Invention

The present invention relates to operating systems, and particularly to a touch-sensitive interface operating system.

2. Description of Related Art

With the development of the technology, a lot of multifunctional electronic devices are produced to satisfy needs of people. Users can control the multifunctional electronic devices via human-computer operating interfaces of the multifunctional electronic devices. Thus, simple human-computer interfaces are endeared by users.

Now, there are two types of human-computer interfaces. One is window interface, and the other is touch-sensitive interface. It is easy to operate the window interface and the touch-sensitive interface. However, when a general electronic device has many functional menu items, it is complicated for the users to repeatedly enter the menu items to find an object. If the object is not found in a submenu, a return key is touched to return a previous menu to find the object in other submenus. This way of find the object in the menu items is inconvenient and time-consuming.

Traditionally, a Global Position System (GPS) is mounted to a car to guide the car to travel along a proper route. If the GPS has an operating-complicated human-computer interface, it is dangerous for drivers to longtime operate the GPS when the car is running.

What is needed is to provide a touch-sensitive interface operating system which is simply operated.

### SUMMARY

An exemplary touch-sensitive interface operating system includes a touch-sensitive panel for inputting at least one graphic instruction, an arithmetic unit, and a database. The arithmetic unit is electrically connected to the touch-sensitive. The database is electrically connected to the arithmetic unit. The database stores information corresponding to the graphic instruction. The touch-sensitive panel is for showing the information.

Other objects, advantages and novel features of the invention will become more apparent from the following detailed description when taken in conjunction with the accompanying drawings, in which:

### BRIEF DESCRIPTION OF THE DRAWINGS

FIG. 1 is a block diagram of a touch-sensitive interface operating system in accordance with a preferred embodiment of the present invention, the operating system includes a touch-sensitive panel;

FIG. 2 is a state of the touch-sensitive panel of FIG. 1;

FIG. 3 is a second state of the touch-sensitive panel of FIG. 1;

FIG. 4 is a third state of the touch-sensitive panel of FIG. 1; and

FIG. 5 is a schematic view of the touch-sensitive panel of FIG. 1.

### DETAILED DESCRIPTION OF THE INVENTION

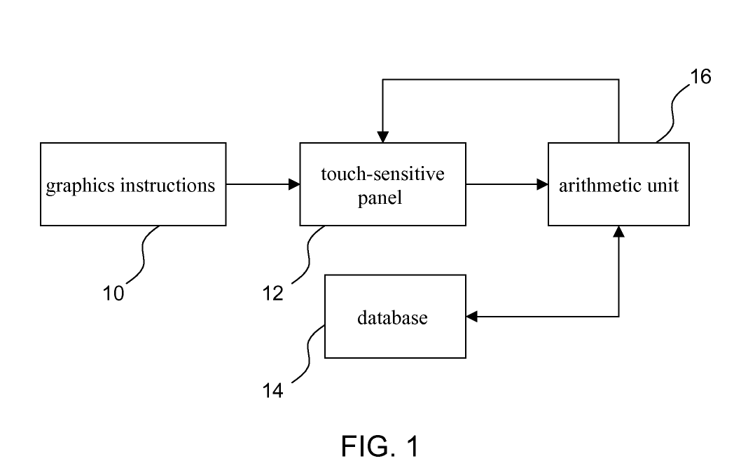

Referring to FIG. 1, a touch-sensitive interface operating system in accordance with a preferred embodiment of the present invention is shown for applying to a Global Position System (GPS), a Personal Digital Assistant (PDA), or a Personal Multimedia Player (PMP). In the GPS, the operating system helps to guide a running route. In the PAD or the PMP, the operating system helps to find an object. The operating system includes a touch-sensitive panel 12, an arithmetic unit 16 electrically connected to the touch-sensitive panel 12, and a database 14 electrically connected to the arithmetic unit 16.

A lot of information stored in the database 14 corresponds to meanings of graphics instructions 10, electronic maps, and etc. The graphics instructions 10 are inputted through the touch-sensitive panel 12. The arithmetic unit 16 receives the graphics instructions 10 and deals with the graphics instructions 10. Then, the arithmetic unit 16 search proper information from the database 14. The information is then shown in the touch-sensitive panel 12.

In this embodiment, the graphics instructions 10 are a plurality of simple graphics symbols which are simple and visual for users to write on the touch-sensitive panel 12. For example,

“S” representing detouring;

“$” representing banks;

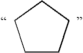

representing home;

“Z” representing hotels;

“Ψ” representing restaurants;

[symbol]

representing satellites;

“?” representing help;

“∇” representing warning settings;

“!” representing overspeed settings;

“+” representing enlarge an electronic map;

“−” representing minish the electronic map;

“<” representing decrease volume;

“>” representing increase volume;

“□” representing menus;

[symbol]

representing battery life;

“2” representing switch the electronic map to a two-dimensional map; and

“3” representing switch the electronic map to a three-dimensional map.

The graphics symbols can be set by programmers or by users.

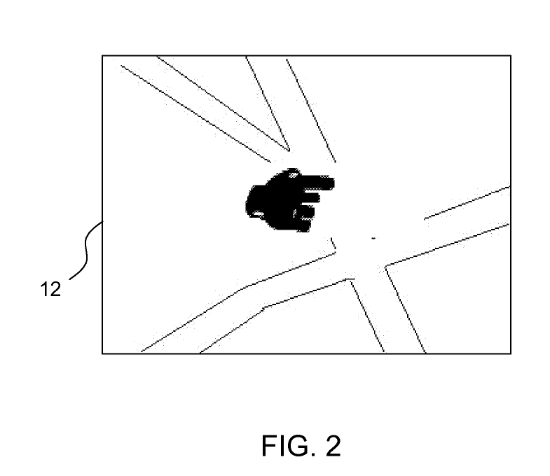

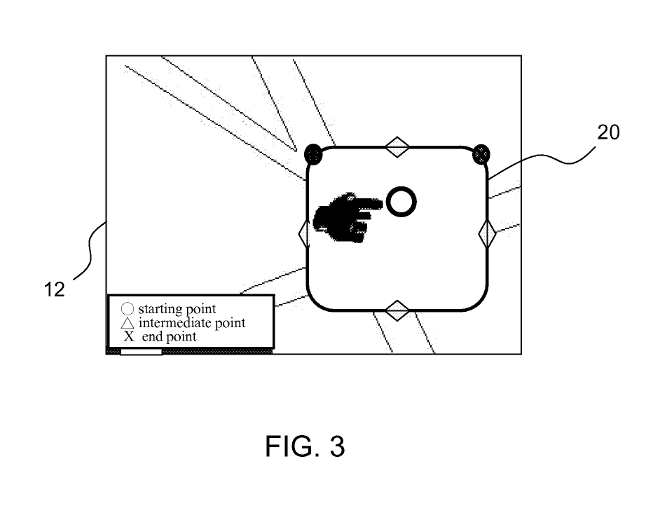

FIGS. 2 and 3 shows an operating system used in a GPS. An electronic map is shown on the touch-sensitive panel 12. When the users touch the touch-sensitive panel 12, a blank portion 20 is shown on a window of the touch-sensitive panel 12. A plurality of graphics symbols is shown in corners of the window to give the users clues. Then the users write graphic symbols on the blank portion 20, such as “◯” that represents a starting point, “Δ” that represents an intermediate point where the users want to pass, “X” that represents an end point. The arithmetic unit 16 works out an optimal route.

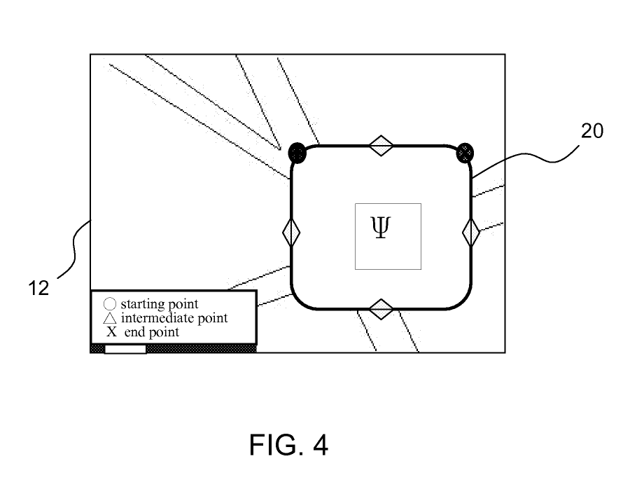

Referring also to FIG. 4, if the users write a landmark graphics symbol on the blank portion 20, such as a restaurant symbol “Ψ”, the arithmetic unit 16 reads relative information and the electronic map from the database 14. A list of restaurants is shown on the touch-sensitive panel 12. A distance and an orientation are also shown on the touch-sensitive panel 12, as shown in a followed table:

| | | |
|---|---|---|
| McDonald's | 1 KM | WE |
| Friday's | 5 KM | E |
| Burger King | 6 KM | NE |
| Tom's Steak | 17 KM | S |

If the users forget graphics symbols, they write “?” on the blank 20 of the touch-sensitive panel 12. An explanation table is shown as followed:

Write “S” presenting you can detour
Write “$” presenting you can find banks
Write “ ” presenting you can go home
Write “Z” presenting you can find hotels
Write “Ψ” presenting you can find restaurants

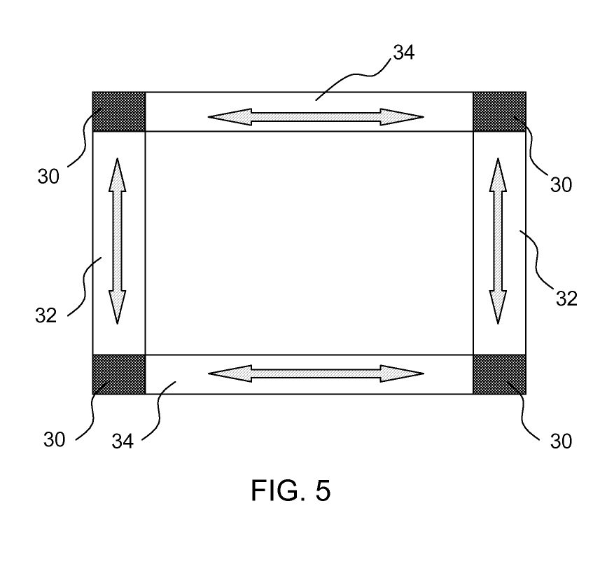

Referring also to FIG. 5, the blank portion 20 is resized. The users touch the diamond-shaped patterns at four sides of the blank portion 20 to resize the blank portion 20. A top left corner and a top right corner of the blank portion 20 are dragging areas for moving the blank portion 20. Operating areas are formed at four sides of the touch-sensitive panel 12. Page turning areas 30 are formed at four corners of the touch-sensitive panel 12. The users touch the turning areas 30 at top and bottom left corners to turn to a previous page. The users touch the turning areas 30 at top and bottom right corners to turn to a following page. Up and down sliding areas 32 are formed at the top and bottom sides of the touch-sensitive panel 12. Left and right sliding areas 34 are formed at the left and right sides of the touch-sensitive panel 12.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

We claim:

1. A touch-sensitive interface operating system for applying to search objects of an electronic map or guide route, comprising:
a touch-sensitive panel for inputting at least one graphic instruction;
a database storing information relative to the at least one graphic instruction, the electronic map, and relative data; and
an arithmetic unit obtaining the information from the database, and showing the information on the touch-sensitive panel.

2. The touch-sensitive interface operating system as claimed in claim 1, wherein the at least one graphic instruction comprises a graphic instruction presenting help, the graphic instruction presenting help is inputted from the touch-sensitive panel, an explanation about operating is shown in the touch-sensitive panel, and the explanation comprises functions of the graphic instruction.

3. The touch-sensitive interface operating system as claimed in claim 1, the at least one graphic instruction comprises a landmark, the arithmetic unit obtains relative information and the relative electronic map stored in the database to shown in the touch-sensitive panel.

4. The touch-sensitive interface operating system as claimed in claim 1, wherein a start point, an intermediate point, and an end point are set in the electronic map, and the arithmetic unit woks out an optimal route.

5. The touch-sensitive interface operating system as claimed in claim 1, wherein the at least one graphic instruction further comprises system-controlling instructions, for adjusting zoom multiples of the electronic map, volume of operating system, and witching the electronic map between two dimension and three dimension.

6. The touch-sensitive interface operating system as claimed in claim 1, wherein a blank portion is formed on the touch-sensitive panel when the electronic map is touched, for inputting the at least one graphic instruction.

7. The touch-sensitive interface operating system as claimed in claim 6, wherein an area of the electronic map that the blank portion contains is an area coverage that the at least one graphic instruction operating on.

8. The touch-sensitive interface operating system as claimed in claim 6, wherein the blank portion is resized via touching a middle of each of sides thereof.

9. The touch-sensitive interface operating system as claimed in claim 6, wherein a top left corner and a top right corner of the blank portion are dragging areas for moving the blank portion.

10. The touch-sensitive interface operating system as claimed in claim 1, wherein a plurality of common-used graphics symbols is shown in corners of the touch-sensitive panel to provide clues.

11. The touch-sensitive interface operating system as claimed in claim 1, wherein operating areas are formed at four sides of the touch-sensitive panel, the operating areas at top and bottom left corners are touched by two fingers to turn to a previous page, the operating areas at top and bottom right corners are touched by two fingers to turn to a following page.

12. The touch-sensitive interface operating system as claimed in claim 11, wherein one finger moves on the operating areas at top and bottom to move a window of the electronic map or a menu.
